(19) United States
(12) Patent Application Publication
(10) Pub. No.: US 2023/0134219 A1
(43) Pub. Date: May 4, 2023

(54) BIOMASS PYROLYSIS DEVICE AND METHOD WITH OPTIMIZED MATCHING OF THERMAL ENERGY AND MICROWAVE ENERGY

(71) Applicant: SOUTHEAST UNIVERSITY, Nanjing (CN)

(72) Inventors: Huiyan ZHANG, Nanjing (CN); Shuping ZHANG, Nanjing (CN); Qing DONG, Nanjing (CN); Rui XIAO, Nanjing (CN); Xiaodi LI, Nanjing (CN)

(21) Appl. No.: 17/642,672

(22) PCT Filed: Dec. 22, 2020
(86) PCT No.: PCT/CN2020/138197

§ 371 Date: Mar. 11, 2022

(30) Foreign Application Priority Data
Jul. 23, 2020 (CN) 202010716642.7

(51) Int. Cl. C10B 53/02; C10B 57/10; C10B 19/00; C10B 27/00; C10B 7/10; C10G 1/02

(52) U.S. Cl. CPC C10B 53/02; C10B 57/10; C10B 19/00; C10B 27/00; C10B 7/10; C10G 1/02; C10G 2300/1011

(57) ABSTRACT

A biomass pyrolysis device and a biomass pyrolysis method is for optimal matching of thermal energy and microwave energy, wherein the device comprises a power generation system, a drying device and a microwave pyrolysis device; wherein the drying device is a cylinder nested with a flue gas layer and a material layer, a material inlet of the drying device is connected with a feeding device, and a volatile outlet is connected with a condensing unit; the microwave pyrolysis device is connected with a material outlet of the drying device, and a pyrolysis gas outlet of the microwave pyrolysis device is connected with the condensing unit; the condensing unit is connected with the power generation system, and waste gas generated by the power generation system is introduced into the flue gas layer of the drying device.

### TECHNICAL FIELD

The present invention relates to a pyrolysis device and a pyrolysis method, and in particular to a biomass pyrolysis device and a biomass pyrolysis method for optimal matching of thermal energy and microwave energy.

### BACKGROUND

Biomass energy is not only renewable energy with wide distribution and large resource quantity but also environment-friendly low-carbon energy, and biomass energy plays an important role in the whole energy system, so that the development of biomass energy is of great significance for improving energy structure and developing green low-carbon economy. Biomass is mainly composed of woody raw materials, herbaceous raw materials, livestock manure, domestic waste, domestic sewage and the like.

At present, thermochemical conversion of biomass resources is achieved mainly by methods such as combustion, pyrolysis and gasification, wherein the pyrolysis is to cut off chemical bonds of macromolecular compounds in biomass by using thermal energy under anaerobic or anoxic conditions, and crack the macromolecular compounds into volatile substances with smaller molecules; meanwhile, the product distribution of pyrolysis products can be regulated by controlling operation parameters, so that biomass energy can be converted into energy products such as biochar, bio-oil and pyrolysis gas.

Traditional heating mode for biomass pyrolysis is characterized in that pyrolysis heat is transmitted from the surface of a biomass feedstock to the inside of the biomass feedstock in a heat conduction or convection mode, while microwave heating converts microwave energy into thermal energy in a dissipation mode. As a unique heating method, microwave heating has obvious advantages in the pyrolysis of solid organic waste, it has fast heating rate, performs uniform heating on the whole raw material, and provides some pyrolysis conditions different from traditional pyrolysis, so that different pyrolysis characteristics are formed, the control for temperature regulation, pyrolysis process and desired final products is easy, and the obtained biochar and bio-oil have high quality and great potential for subsequent utilization. However, the microwave absorption capability of the biomass feedstock is weak, and it is difficult to increase the heating rate merely by the microwave absorption factors (moisture and trace elements such as Na⁺ and K⁺,) in biomass; therefore, it is necessary to bake and carbonize the biomass feedstock in the traditional heating mode in advance to increase its absorption constant and improve the utilization of microwave energy.

### SUMMARY

Objective: The present invention aims to provide a biomass pyrolysis device and a biomass pyrolysis method for optimal matching of thermal energy and microwave energy, which reasonably utilize energy, and are green and environment-friendly.

Technical scheme: The biomass pyrolysis device for optimal matching of thermal energy and microwave energy of the present invention comprises a feeding device and a condensing unit, and further comprises a power generation system, a drying device and a microwave pyrolysis device; wherein the drying device is a cylinder nested with a flue gas layer and a material layer, a material inlet of the drying device is connected with a feeding device, and a volatile outlet is connected with a condensing unit; the microwave pyrolysis device is connected with a material outlet of the drying device, and a pyrolysis gas outlet of the microwave pyrolysis device is connected with the condensing unit; the condensing unit is connected with the power generation system, and waste gas generated by the power generation system is introduced into the flue gas layer of the drying device.

The biomass pyrolysis method for optimal matching of thermal energy and microwave energy of the present invention based on the pyrolysis device described above comprises:
(1) feeding a material into the drying device through the feeding device for drying, and providing a drying heat source by waste gas generated after the combustion of pyrolysis gas;
(2) performing pyrolysis on the dried material, and condensing the generated pyrolysis gas;
(3) feeding the residual non-condensed gas after purification into an internal combustion engine for combustion, wherein the waste gas generated by combustion is the drying heat source in the step (1), the temperature is 400-600 ° C., the internal combustion engine is connected with a generator, and the generated electrical energy supplies energy for the pyrolysis process in the step (2); and
(4) treating the waste gas after heat exchange by the drying device and then discharging the waste gas.

Beneficial effects: The present invention has the following remarkable advantages compared with the prior art.

According to the present invention, a biomass feedstock is baked by adopting thermal energy, the microwave absorption constant of the biomass feedstock is increased, and then the biomass feedstock is fed into the microwave pyrolysis device, so that the pre-carbonized biomass in microwave has higher energy absorption efficiency and the greatly improved energy utilization, so as to achieve the purpose of optical matching of thermal energy and microwave energy; meanwhile, biomass energy can be high-efficiently converted into chemical raw materials or fuels, and these products have very broad prospects for their characteristics, which can not only improve the economic value of biomass but also alleviate environmental pollution and energy problems.

### BRIEF DESCRIPTION OF THE DRAWINGS

FIG. 1 is a schematic diagram of the structure of the device disclosed herein; and

FIG. 2 is a cross-sectional view of the drying device of the present invention.

### DETAILED DESCRIPTION

The technical scheme of the present invention is further described below with reference to the drawings.

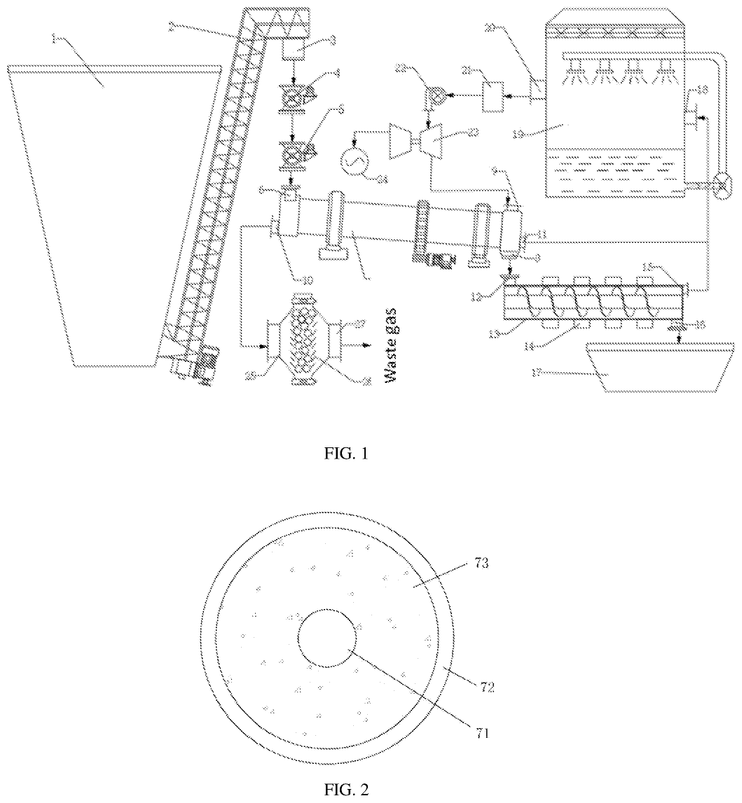

As shown in FIG. 1, the present embodiment comprises a feeding device, a condensing unit 19, a power generation system, and a drying device 7 and a microwave pyrolysis device 13 arranged between the feeding device and the condensing unit 19.

The feeding device comprises a material bin 1, a screw elevator 2 and two air lockers, the material bin 1 is connected with the screw elevator 2, an outlet 3 of the screw elevator is connected with the air locker 4, the air locker 4 is connected with the air locker 5, and the air locker 5 is connected with a material inlet 6 of the drying device 7.

The drying device 7 is a cylinder nested with a flue gas layer and a material layer. The drying device 7 is provided with a first flue gas layer 71 along a central axis and a second flue gas layer 73 along an outer wall, and an annular space between the first and second flue gas layers is the material layer 72. An inlet 9 of the flue gas layer is connected with a waste gas outlet of the power generation system and is supplied with heat by the waste gas of the power generation system. The design that the flue gas layer and the material layer are nested can not only fully utilizes the heat of waste gas, but also make the flue gas and the material fully exchange heat, thereby improving drying efficiency.

A material outlet 8 of the drying device 7 is connected with the microwave pyrolysis device 13, and a coke outlet 16 of the microwave pyrolysis device 13 is connected with a carbon storage bin 17. The microwave pyrolysis device 13 comprises a microwave generator 14 arranged on the surface of the microwave pyrolysis device and a screw conveyor arranged at the central axis of the inside of the microwave pyrolysis device. A pyrolysis gas outlet 15 of the microwave pyrolysis device 13 and a volatile outlet 11 of the drying device 7 are connected with a gas inlet 18 of the condensing unit 19. Volatile component gas and pyrolysis gas are condensed in the condensing unit.

The condensing unit 19 is a spray tower-type device, a spray layer is arranged inside of the condensing unit, one side of the condensing unit 19 is provided with a gas inlet, the other side thereof is provided with a gas outlet, and the inlet and the outlet have height difference, so that the condensable components in the gas are fully condensed. The non-condensed combustible gas is discharged from an outlet 20 of the condensing unit and introduced into the power generation system.

The power generation system comprises a gas purification device 21, an induced draft fan 22, an internal combustion engine 23 and a generator 24 sequentially arranged behind the condensing unit 19. The non-condensable gas is purified and fed to the internal combustion engine for combustion, the heat provided by combustion enables the generator 24 to generate power, and the power is used for supplementing electrical energy of the microwave generator in the microwave pyrolysis device 13, so as to realize the full utilization of resources and energy. The internal combustion engine 23 is also connected with the flue gas layer of the drying device 7, an outlet 10 of the flue gas layer is connected with a waste gas purification device 26, and the flue gas after heat exchange is treated and then discharged. Different power generation devices can be selected according to biomass treatment capacity, and the present embodiment takes an internal combustion engine as an example.

The specific working principle of the present device is as follows.

A biomass feedstock is fed out from the material bin 1 through the material outlet 3 of the screw elevator 2, and introduced into the drying device 7 through the air locker 4 and the air locker 5 from the material inlet 6 of the drying device 7, and the biomass feedstock is dried and baked at a temperature of 250-350° C. to remove moisture from the biomass feedstock and partially pre-carbonize it. The generated volatile gas is introduced into the condensing unit 19 from the gas outlet 9.

The dried and upgraded biomass is introduced into a heater from a material inlet 12 of the microwave pyrolysis device 13, and is subjected to deep pyrolysis under the heating action of the microwave generator. The generated biochar is introduced into the carbon storage bin 17 through the material outlet for storage and collection. The generated pyrolysis gas is introduced into the spray-type condenser 19 through the gas outlet 15 to collect bio-oil.

The non-condensed combustible gas in the spray-type condenser 19 is discharged into the internal combustion engine 23 through the gas purification device 21 by the induced draft fan 22 for combustion, which drives the generator 24 to generate power. High-temperature waste gas generated by combustion is introduced into the rolling-type drying-baking device 7 as a heat source, and the exhaust gas generated after heat exchange and drying-baking is introduced into the waste gas purification device 26 and then is discharged.

Biomass is introduced into the rolling-type drying-baking device through two air lockers under the action of the elevator. After drying and baking, the moisture in the biomass is removed and the raw material is partially pre-carbonized. Subsequently, the upgraded biomass is introduced into the microwave pyrolysis section through the screw elevator for deep pyrolysis to obtain biochar with higher quality. The generated pyrolysis gas is collected by the spray-type condenser to obtain bio-oil with high quality. Meanwhile, the internal combustion engine enables the power generation system to generate electrical energy, the electrical energy is used for supplementing energy consumption of the microwave pyrolysis device, and the waste gas is used for heating the drying-baking section; the system has high energy efficiency and no exhaust gas emission during operation, and the operation parameters can be adjusted according to the biomass feedstock, so that the system has high operation safety and low cost.

What is claimed is:

1. A biomass pyrolysis device for optimal matching of thermal energy and microwave energy, comprising: a feeding device and a condensing unit (19), and further comprising: a power generation system, a drying device (7) and a microwave pyrolysis device (13); wherein the drying device (7) is a cylinder nested with a flue gas layer and a material layer, a material inlet (6) of the drying device is connected with the feeding device, and a volatile outlet (11) is connected with the condensing unit (19); the microwave pyrolysis device (13) is connected with a material outlet (8) of the drying device (7), and a pyrolysis gas outlet (15) of the microwave pyrolysis device (13) is connected with the condensing unit (19); the condensing unit (19) is connected with the power generation system, and waste gas generated by the power generation system is introduced into the flue gas layer of the drying device (7).

2. The biomass pyrolysis device for optimal matching of thermal energy and microwave energy according to claim 1, wherein the drying device (7) is provided with a first flue gas layer (71) along a central axis and a second flue gas layer (73) along an outer wall, and an annular space between the first and second flue gas layers is a material layer (72).

3. The biomass pyrolysis device for optimal matching of thermal energy and microwave energy according to claim 1, wherein electrical energy generated by the power generation system is used for supplementing energy consumption of the microwave pyrolysis device (13).

4. The biomass pyrolysis device for optimal matching of thermal energy and microwave energy according to claim 1, wherein the microwave pyrolysis device (13) comprises a microwave generator (14), a screw conveyor arranged at a central axis of the microwave pyrolysis device, and a carbon storage bin (17) connected with the microwave pyrolysis device (13).

5. The biomass pyrolysis device for optimal matching of thermal energy and microwave energy according to claim 1, wherein the feeding device comprises a material bin (1), a screw elevator (2) and an air locker arranged at an outlet (3) of the screw elevator, the screw elevator (2) is connected with a material outlet at the bottom of the material bin, and an outlet of the air locker is connected with the drying device.

6. The biomass pyrolysis device for optimal matching of thermal energy and microwave energy according to claim 1, wherein an outlet (10) of the flue gas layer of the drying device (7) is connected with a waste gas purification device (26).

7. The biomass pyrolysis device for optimal matching of thermal energy and microwave energy according to claim 1, wherein the condensing unit (19) is a spray tower.

8. A biomass pyrolysis method for optimal matching of thermal energy and microwave energy based on the pyrolysis device of claim 1, comprising:
(i) feeding a material into the drying device through the feeding device for drying, and providing a drying heat source by waste gas generated after the combustion of pyrolysis gas;
(ii) performing pyrolysis on the dried material, and condensing the generated pyrolysis gas;
(iii) feeding the residual non-condensed gas after purification into an internal combustion engine for combustion, wherein the waste gas generated by combustion is the drying heat source in the step (i), the temperature is 400-600 ° C., the internal combustion engine is connected with a generator, and the generated electrical energy supplies energy for the pyrolysis process in the step (ii); and
(iv) treating the waste gas after heat exchange by the drying device and then discharging the waste gas.

9. The biomass pyrolysis method for optimal matching of thermal energy and microwave energy according to claim 8, wherein a ratio of the thermal energy consumed by the drying-baking section, the electrical energy consumed by the pyrolysis section and the electrical energy generated by the generator is changed by adjusting mass loss rate of the drying-baking section.
